(19) United States
(12) Patent Application Publication
(10) Pub. No.: US 2023/0021796 A1
(43) Pub. Date: Jan. 26, 2023

(54) METHOD FOR OPERATING AN ELECTRIC VEHICLE AND ELECTRIC VEHICLE

(71) Applicant: SEW-EURODRIVE GMBH & CO. KG, Bruchsal (DE)

(72) Inventors: Patrick WEIS, Wössingen (DE); Gero BOCKELMANN, Bruchsal (DE); Matthias HAUCK, Schwetzingen (DE)

(73) Assignee: SEW-EURODRIVE GMBH & CO. KG, Bruchsal (DE)

(21) Appl. No.: 17/787,811

(22) PCT Filed: Dec. 2, 2020
(86) PCT No.: PCT/EP2020/025559

§ 371 Date: Jun. 21, 2022

(30) Foreign Application Priority Data
Dec. 18, 2019 (DE) 10 2019 008 790.9

(51) Int. Cl. B60L 3/00; H02J 7/00; H02J 7/34; B60L 53/20; B60L 50/60; B60L 58/12; B60L 58/16; B60L 3/04; H01M 10/42; H01M 10/48; H01M 10/44

(52) U.S. Cl. CPC B60L 3/0046; H02J 7/0013; H02J 7/0048; H02J 7/007; H02J 7/005; H02J 7/00308; H02J 7/00304; H02J 7/00309; H02J 7/345; B60L 53/20; B60L 50/60; B60L 58/12; B60L 58/16; B60L 3/04; H01M 10/4264; H01M 10/486; H01M 10/443; H01M 10/48; H01M 10/44; H02J 2207/50; H02J 2207/20; H02J 2310/48; H02H 3/10

(57) ABSTRACT

In a method for operating an electric vehicle and an electric vehicle, including an electric traction drive device for driving vehicle, a control device for controlling the driving, a first energy storage device, for supplying the control device using a first DC voltage, a second energy storage device, for supplying the traction drive device using a second DC voltage, and an energy supply unit for providing an output DC voltage, the first energy storage device is connected to the second energy storage device via a converter device, the first energy storage device is connected to the energy supply unit, the converter device converts the first DC voltage into the second DC voltage, and a power flow from the second energy storage device to the first energy storage device is prevented.

### FIELD OF THE INVENTION

The present invention relates to a method for operating an electric vehicle and an electric vehicle.

### BACKGROUND INFORMATION

A driverless, mobile assistance system is, for example, provided as an electric vehicle. Alternatively, such a vehicle can also be designated as a driverless transport vehicle (DTV) or AGV (automated guided vehicle).

A driverless transport vehicle for transporting loads is described in German Patent Document No. 10 2007 002 242. Such a load transport can be designated as an intralogistic application. The driverless transport vehicle is supplied with energy inductively.

An industrial conveyor belt system is described in German Patent Document No. 195 45 544, in which the vehicles are supplied with electrical energy via contact lines. In order to be able to operate the vehicle even when there is no external energy supply, it is described that electrolytic or gold cap capacitor stores, also referred to as ultracapacitors, supercapacitors, or double-layer capacitors, can be used as the electrical energy source.

An ultracapacitor power supply for an electric vehicle is described in U.S. Pat. No. 6,265,851. This electric vehicle has two energy storage devices which can alternately be used to drive the vehicle.

A driverless transport system is described in European Patent Document No. 2 419 364, which has two energy storage devices—a double-layer capacitor device and a battery device. In normal operation, the double-layer capacitor device supplies the drive device, i.e., the motor, with energy. In an emergency, i.e., when the voltage in the double-layer capacitor device falls below a certain level, the system switches to battery operation. The drive device is then supplied with energy exclusively by the battery device until the double-layer capacitor device is recharged at a charging station.

A method for operating an electric vehicle and an electric vehicle are described in German Patent Document No. 10 2017 005 153, in which the vehicle has a hybrid storage device and a double-layer capacitor device. Both storage devices can alternately supply the traction drive device with energy.

A power supply system for electric vehicles is described in European Patent Document No. 2 535 218.

### SUMMARY

Example embodiments of the present invention provide for the energy management of an electric vehicle, e.g., a driverless, mobile assistance system which has two different types of energy stores.

According to an example embodiment of the present invention, in a method for operating an electric vehicle, e.g., a driverless, mobile assistance system (MAS) of an intralogistics application, the vehicle has an electric drive device for the driving movement, e.g., traction, of the vehicle, a control device for controlling the driving movement of the vehicle, a first energy storage device, e.g., a rechargeable battery storage device, for supplying the control device with a first DC voltage, a second energy storage device, e.g., a double-layer capacitor device and/or which can be charged and discharged more quickly than the first energy storage device, for supplying the traction drive device with a second DC voltage, and an energy supply unit which, e.g., in certain time intervals, provides an output DC voltage, the first energy storage device is connected, e.g., electrically connected, to the second energy storage device via a converter device, the first energy storage device is connected, e.g., electrically connected, to the energy supply unit, e.g., such that the output DC voltage substantially equals the first DC voltage, the converter device converts the first DC voltage into the second DC voltage, e.g., the first DC voltage is less than the second DC voltage and/or the first DC voltage is a low voltage, a power flow from the second energy storage device to the first energy storage device is prevented. It is considered advantageous that the second energy storage device can be configured such that the second energy storage device provides the required drive energy for the MAS in normal operation. The second energy storage device is usually used almost completely during journeys and is recharged during breaks in the logistics process. The capacity of the second energy storage device is adaptable to the requirements of the logistics process and substantially depends on the distance traveled without an external energy supply, i.e., when the energy supply unit does not provide any power. Because a flow of power from the second energy storage device to the first energy storage device is prevented, with known routes, the capacity of the second energy storage device can be selected accordingly and optimally adapted to the requirements. In contrast, a power flow from the first energy storage device to the second energy storage device is possible. This is considered advantageous in an emergency, i.e., in unforeseen exceptional situations, since energy can be recharged from the first energy storage device to the second energy storage device if, for example, the second energy storage device is empty and without an external energy supply. A standstill of the vehicle is thus preventable. Although the first energy storage device is also recharged during the logistical breaks, it has to be configured such that its energy can supply the control device, i.e., the control electronics, for longer periods of time and, if necessary, can provide drive energy in an emergency, i.e., in the event of disturbances. Disturbances can be, for example, unexpected obstacles or people on the route, but also delays in coupling to other processes that are not yet ready. In contrast, the supply of the control device is taken over during the entire process by the first energy storage device, which is, for example, configured for the longest expected time until the next charging.

The first energy storage device, for example, has a higher energy density and therefore has a lower power density and a lower number of possible charging/discharging cycles in comparison to the second energy storage device. The second energy storage device can, for example, be charged and discharged faster than the first energy storage device.

The first energy storage device is, for example, configured as a battery store. One example of a battery storage device is an arrangement of one or more secondary electrochemical elements, e.g., based on nickel and/or iron. Such a secondary electrochemical element includes a negative electrode, a positive electrode, a porous separator which separates the negative and the positive electrode from one another, and an electrolyte, e.g., an aqueous alkaline one, using which the electrodes and the separator are impregnated. Such a secondary electrochemical element based on nickel and/or iron is capable, like a capacitor, of delivering high pulse currents very quickly, but otherwise it displays more of a battery behavior, in particular the capacitor equations Q=C U and W=½ C U² do not apply to this storage device. Such a battery storage device has a higher cycle stability. This cycle stability is in the range between 1000 and 20000. Charging and discharging cycles can therefore be carried out more frequently before the performance criteria of the battery storage device are no longer met. In addition, the battery storage device has overcharge stability and deep discharge stability. It can be charged quickly at up to 15 C. The battery storage device can nevertheless be charged and discharged more slowly than a double-layer capacitor device, which is an arrangement for the second energy storage device. The double layer capacitor device is characterized in that it can be charged in a few seconds and fully discharged to zero voltage. Its cycle stability is in the range of 1 million.

According to example embodiments, the first DC voltage is an extra-low voltage, for example, 12V, 24V, 48V, or 96V. Since the first energy storage device is typically a wearing part and is not configured for the service life of the vehicle, the first energy storage device can be replaced by a person who is not correspondingly trained. The risk to the person is reducible.

According to example embodiments, the power flow from the second energy storage device to the first energy storage device is prevented by configuring the converter device as a unidirectional DC/DC converter, e.g., as a step-up converter or as a flyback converter.

It is considered advantageous that the flow of power from the second energy storage device to the first energy storage device is prevented with a simultaneous voltage conversion. The unidirectional DC/DC converter is provided such that a power flow is only possible from the first energy storage device to the second energy storage device. If the first DC voltage is, for example, less than the second DC voltage, the unidirectional DC/DC converter is, for example, arranged as a step-up converter or a flyback converter. These converters convert an input voltage into a higher output voltage, and the voltage conversion is only possible in this direction. It is considered advantageous in the case of the flyback converter that there is a potential isolation, so that the two voltage levels of the first DC voltage and the second DC voltage are galvanically isolated and an electrically safe separation of the drive supply and electronics supply can thus be made possible. Since only one power flow direction is provided, a cost-effective electronic circuit can be used despite potential isolation. This would not be possible with a bidirectional circuit.

According to example embodiments, the vehicle furthermore has an energy storage control device, and at least one state value of the first energy storage device is detected and transmitted to the energy storage control device, e.g., a first state value is a voltage present at the first energy storage device and/or a second state value is a current flowing through the first energy storage device and/or a third state value is a temperature prevailing in the first energy storage device.

It is considered advantageous that state monitoring of the first energy storage device is made possible and, if necessary, it is possible to react to changed states of the first energy storage device.

The expression “furthermore” is to be understood such that the energy storage control device is a separate unit and is therefore arranged separately from the control device of the vehicle. The energy storage control device is, for example, integrated in one structural unit together with the first energy storage device.

For example, sensors such as current, voltage, and/or temperature sensors are provided on the first energy storage device to detect the state values. The detection is therefore executable, for example, by directly measuring the variables. However, it is also possible that the variables are not measured directly, but are calculated. There is, for example, a communication connection between the energy storage control device and the control device.

The current flowing through the first energy storage device is denoted by I₁. The values of the current I₁ can be positive or negative. A positive current I₁ is understood to mean a current which supplies energy to the first energy storage device. I₁>0 is therefore to be understood as a charging current. A negative current I₁ is understood to mean a current which draws energy from the first energy storage device. I₁<0 is therefore to be understood as a discharging current.

According to example embodiments, an output current provided by the energy supply unit is regulated or controlled by the energy storage control device as a function of the at least one state value, e.g., a value for the current flowing through the first energy storage device is specified as the setpoint value.

It is considered advantageous that the regulation or control of the required charging current by the energy storage control device is provided. The regulation or control of the charging current thus does not have to be carried out by the energy supply unit. This is only configured such that it has a current source which can be regulated or controlled, so that the value of the output current is influenceable. This makes it possible to use a feed as an energy supply unit, i.e., a charger. Charger and converter devices do not depend on the properties of the first energy storage device. For this reason, standard components can be used for the charger and the converter device, and there is no additional variance in dependence on different types of first energy storage devices. An intelligent energy storage device is provided, for example, which controls or regulates the charger and thus determines the required charging current depending on the present state. This functions independently of any possible load current via the converter device. For example, the energy storage control device switches off the charger and only has the voltage of the first energy storage device as a measured variable. In a more complex case, the charger receives a specification for the level of the charging current from the energy storage control device, and the state of the first energy storage device is detected on the basis of voltage, current, and temperature.

According to example embodiments, the energy storage control device determines at least one application parameter from the at least one state value, e.g., the at least one application parameter is transmitted to the control device, e.g., a first application parameter is a value for that current using which the first energy storage device can be discharged at most, and/or a second application parameter is a state of charge of the first energy storage device and/or a third application parameter is an aging state of the first energy storage device.

It is considered advantageous that logistical processes can be planned better and it is possible to react more flexibly to short-term changes or disruptions in the course of the logistical application. If the application parameter is the aging state, a replacement of the first energy storage device can be prompted so that a failure of the control of the electric vehicle is preventable.

According to example embodiments, a power flow, e.g., from the energy supply unit, to the first energy storage device is prevented if a voltage applied at the first energy storage device exceeds a definable maximum voltage and/or if a current flowing through the first energy storage device exceeds a definable maximum current and/or if a temperature prevailing in the first energy storage device exceeds a definable first maximum temperature.

It is considered advantageous that overloading or destruction of the first energy storage device, e.g., due to overcharging, is preventable. In this case, the maximum current is a positive value for the current I₁ and the maximum permissible charging current of the first energy storage device. For example, a switch activatable by the energy storage control device is used in order to disconnect the electrical connection between the first energy storage device and the energy supply unit.

According to example embodiments, a power flow from the first energy storage device, e.g., to the second energy storage device, is prevented if a voltage applied at the first energy storage device falls below a predeterminable minimum voltage and/or if a current flowing through the first energy storage device falls below a definable minimum current and/or if a temperature prevailing in the first energy storage device falls below a definable second maximum temperature.

It is considered advantageous that overloading or destruction of the first energy storage device due to excessively high discharging currents and/or temperatures in absolute value is preventable. In this case, the minimum current is a negative value for the current I₁ and the maximum permissible discharging current in absolute value of the first energy storage device. The minimum voltage is a voltage value below which the first energy storage device is deactivated. This avoids a complete discharge of the first energy storage device. For example, a switch activatable by the energy storage control device is used in order to disconnect the electrical connection between the first energy storage device and the second energy storage device. The second maximum temperature is equal to the first maximum temperature, for example.

According to example embodiments, the power flow from and to the first energy storage device is prevented by a bidirectional switch, e.g., the bidirectional switch is activated by the energy storage control device. It is considered advantageous that destruction of the first energy storage device is preventable. A bidirectional switch is understood to mean a switch which can disconnect power flows from and to the first energy storage device separately and independently of one another.

According to example embodiments, energy is supplied to the energy supply unit with or without contact and/or in certain time intervals while driving.

The advantage of the contact-type energy supply is that charging of the energy store is provided, for example, by a plug.

The advantage of the contactless supply of energy is that safe charging of the energy store is provided, for example, by induction.

According to example embodiments, the energy supply unit includes a rectifier, which is fed from a secondary inductance of the electric vehicle, e.g., to which a capacitance is connected in series or in parallel such that the resonant frequency of the resonant circuit formed in this manner is equal to the frequency of an alternating current applied in a stationary primary inductance. The inductive transfer of energy also increases safety and there is no wear and tear on the charging contacts that would otherwise be required. In addition, a safe-to-touch configuration is implementable.

It is considered in the energy supply at certain time intervals while driving that the energy supply is executable on sections of the route and thus the two energy storage devices can either be recharged or their state of charge is kept fully charged and their service life is therefore extendable, since they are exposed to as few full charging cycles as possible, e.g., they are not frequently fully charged and discharged. The aging is thus reduced. The energy supply is executable with contacts, for example, by conductor lines. Alternatively, a stationary primary conductor is arranged along the route, via which energy is transferred inductively to a secondary inductance arranged in the electric vehicle.

According to an example embodiment of the present invention, in a device for supplying a first consumer of an electric vehicle, e.g., a driverless, mobile assistance system of an intralogistics application, including a first DC voltage and a second consumer with a second DC voltage, the device includes a first energy storage device, e.g., a rechargeable battery storage device, a second energy storage device, e.g., a double-layer capacitor device and/or which can be charged and discharged more quickly than the first energy storage device, and an energy supply unit, which can be used to provide an output DC voltage, e.g., in certain time intervals, the first DC voltage can be drawn from the first energy storage device, the second DC voltage can be drawn from the second energy storage device, the first energy storage device is connected, e.g., electrically connected, to the second energy storage device via a converter device, e.g., a unidirectional DC/DC converter, a step-up converter, or a flyback converter, the first energy storage device is connected, e.g., electrically connected, to the energy supply unit, e.g., such that the output DC voltage substantially equals the first DC voltage, the first DC voltage is convertible into the second DC voltage by the converter device, e.g., the first DC voltage is lower than the second DC voltage, e.g., the first DC voltage is an extra-low voltage, e.g., the device is configured such that a power flow from the second energy storage device to the first energy storage device is prevented. It is considered advantageous that a deliberate storage configuration for supplying the second consumer is made possible.

According to example embodiments, the vehicle furthermore has an energy storage control device, and the device is configured such that at least one state value of the first energy storage device is detectable and transmittable to the energy storage control device, e.g., a first state value is a voltage applied at the first energy storage device and/or a second state value is a current flowing through the first energy storage device and/or a third state value is a temperature prevailing in the first energy storage device.

It is considered advantageous that state monitoring of the first energy storage device is made possible and, if necessary, it is possible to react to changed states of the first energy storage device.

According to example embodiments, an output current provided by the energy supply unit can be regulated or controlled by the energy storage control device as a function of the at least one state value, e.g., a value for the current flowing through the first energy storage device is specifiable as the setpoint value.

It is considered advantageous that the required charging current can be regulated or controlled by the energy storage control device. The charging current does not have to be regulated or controlled by the energy supply unit. This is only configured such that it has a current source which can be regulated or controlled, so that the value of the output current is influenceable. This makes it possible to use a feed as an energy supply unit, i.e., a charger.

According to example embodiments, the device furthermore has a bidirectional switch by which a power flow from and to the first energy storage device is preventable, e.g., in certain time intervals, e.g., the bidirectional switch is activatable by the energy storage control device.

It is considered advantageous that the first energy storage device can be protected against overload. For example, if the voltage applied at the first energy storage device exceeds a definable maximum voltage and/or if a current flowing through the first energy storage device exceeds a definable maximum current and/or if a temperature prevailing in the first energy storage device exceeds a definable first maximum temperature and/or if a voltage applied to the first energy storage device falls below a definable minimum voltage and/or if a current flowing through the first energy storage device falls below a definable minimum current and/or if a temperature prevailing in the first energy storage device exceeds a definable second maximum temperature.

According to example embodiments, the first energy storage device, the energy storage control device, and the bidirectional switch are combined in one structural unit, e.g., the structural unit is arranged on the device so that it can be separated such that a replacement of the structural unit is provided.

It is considered advantageous that an intelligent energy storage unit can be provided, which is replaceable. The central controller does not have to be adapted to a new intelligent energy storage unit since the controller, i.e., the charging management, of the first energy storage device is managed by the intelligent energy storage unit itself.

According to example embodiments, an electric vehicle, e.g., a driverless, mobile assistance system of an intralogistics application, e.g., for carrying out a method described herein, has a device according described herein, a first consumer, and a second consumer, the first consumer is a control device for controlling the driving movement of the vehicle and/or the second consumer is an electric traction drive device for the driving movement, e.g., traction, of the vehicle or a lifting device or a handling device.

It is considered advantageous that the control device on the one hand and the controlled consumers on the other each have their own power supply at different voltage levels.

Further features and aspects of example embodiments of the present invention are described in more detail below with reference to the appended schematic Figures.

### BRIEF DESCRIPTION OF THE DRAWINGS

A device for the voltage supply of two consumers of a mobile assistance system according to an example embodiment of the present invention is schematically illustrated in FIG. 1.

The mobile assistance system is also referred to as MAS.

A mobile assistance system having two consumers is schematically illustrated in FIG. 2.

A mobile assistance system having two consumers and an intelligent battery is schematically illustrated in FIG. 3.

FIG. 4 schematically illustrates an intelligent battery illustrated in FIG. 3 in detail.

### DETAILED DESCRIPTION

FIG. 1 illustrates a device for the voltage supply of two consumers using the DC voltages U₁ and U₂. For this purpose, the device has a first DC voltage connection 1 and a second DC voltage connection 2, at which the DC voltages U₁ and U₂ are applied, as illustrated. For the energy supply, the device has an energy supply unit 3 which, for example, includes a regulator 4 and a variable current source 5. The energy supply unit can also be designated as a charger 3. The regulator regulates the output current I₀ of the charger 3 and thus controls the output DC voltage U₀. The charger 3 is connected to the first DC voltage connection 1 without a voltage converter. For example, the output DC voltage U₀ substantially corresponds to the first DC voltage U₁, since no consumer is connected in series between the charger 3 and the first DC voltage connection 1.

The first DC voltage U₁ at the first DC voltage connection differs from the second DC voltage U₂. DC voltages U₂ in the range of low voltages, e.g., in the range between 120 V and 600 V, e.g., 300 V, and DC voltages U₁ in the range of extra-low voltages, e.g., 12 V, 24 V, 48 V, or 96 V, may be provided for the use of the device in a MAS.

In order to convert the first DC voltage U₁ into the higher second DC voltage U₂, a converter device 8 is present between the charger and the second DC voltage connection 2. The converter device 8 is connected in parallel to the first DC voltage connection 1, so that the converter device 8 also uses the output DC voltage U₀ as the input voltage.

The device has two energy stores 6, 7 for buffering and energy storage. For example, the first energy store 6 is in the form of a battery store and is arranged, for example, as a secondary electrochemical element. For example, the second energy store 7 is arranged as a double-layer capacitor. In the illustrated exemplary embodiment, only a first and a second energy store are illustrated, for example. However, modularly constructed energy storage devices are also possible, which each include multiple identical or different energy stores.

Each energy store is supplied with energy by the charger. This energy can be stored and made available to a corresponding consumer. The double-layer capacitor 7 exclusively provides the energy for those consumers that can be supplied with the second DC voltage U₂. The converter device 8 prevents transfer charging from the double-layer capacitor 7 to the battery store 6. In the exemplary embodiment illustrated in FIG. 1, the converter device 8 is arranged as a flyback converter. The flyback converter is a potential-isolated unidirectional DC/DC converter. Due to the construction, it has a diode 9, through which a power flow or energy flow from the double-layer capacitor to the battery store is prevented at any point in time, i.e., at all times. This provides for the double-layer capacitor to be configured deliberately to meet the needs of the consumer connected to it.

FIG. 2 schematically illustrates an application of the device for the voltage supply of two consumers in a MAS. In this example, the converter device 8 is arranged as a step-up converter, which is an example of a non-potentially-isolated DC/DC converter. A power flow from the double-layer capacitor 7 to the battery store 6 is thus prevented here as well.

In the illustrated exemplary embodiment, the first consumer 10 is in the form of a vehicle controller. Among other things, this controls the driving movement of the MAS. The controller is supplied with the first DC voltage U₁, which is, for example, 12V, 24V, 48V, or 96V. Other consumers, which can generally be designated as vehicle electronics, can also be supplied with this DC voltage U₁, for example, safety sensors such as laser scanners and corresponding evaluation electronics.

For the driving movement, the MAS has a drive device 11, which can be implemented, for example, as a 3-phase AC motor having an upstream 3-phase inverter. The inverter converts the second DC voltage U₂ into a 3-phase AC voltage, using which the three-phase AC motor, for example, a squirrel-cage rotor, is operated. The drive device 11 can also have multiple motors, each of which is operable by its own inverter. In addition, the inverter can also be provided with feedback capability, so that it is possible to charge the double-layer capacitor 7 when the drive motors are operated in generator mode. In addition to drive devices for traction of the MAS, other consumers for the second DC voltage U₂ are also possible, such as lifting devices for picking up a load or handling devices for moving an object, for example, a robot arm. These loads 11 are supplied using the second DC voltage U₂ in the range from 120V to 600V.

For example, transfer charging from the battery store 6 to the double-layer capacitor 7 is possible. This is considered advantageous if the double-layer capacitor is drained due to an unforeseen disturbance, i.e., in an emergency. For example, it is possible that the battery store also provides energy for driving the vehicle. Another example for the transfer charging of energy from the first to the second energy store is switching the vehicle back on after a long break without the charger having to supply energy. Even if all consumers 10 and 11 are switched off when the vehicle is stationary, for example, when parking, the energy content of the two energy storage devices decreases due to self-discharge. In a double-layer capacitor, this self-discharge is many times greater than in a battery store. The second energy store can therefore be drained after a break of just a few hours or a few days, despite the consumers 11 being switched off. By transfer charging energy from the first to the second store, the MAS can be put back into a ready-to-drive state even after a longer break, without the charger 3 having to provide energy. In other words, the MAS does not have to be placed or parked in a place where an external power supply is available.

The charger 3 for the vehicle can be configured in different manners. For example, a charger having a plug contact is implementable, so that the MAS can be supplied with energy by contact at specific charging stations. Likewise, a contact-based energy supply is implementable during the journey of the MAS, for example, by conductor lines. Alternatively, a contactless energy supply is implementable, for example, an inductive energy supply. This can take place through coupled primary and secondary inductances. A supply at stationary charging stations and also a supply during driving of the MAS are both also possible, for example, through primary conductors laid in or on the whole floor. Such a primary conductor is, for example, a line conductor or a coil.

The energy stores are primarily adapted to supply the MAS with energy during operating phases in which the MAS does not have an external energy supply as described above. These can be journeys between stationary charging stations or journeys away from the primary conductor or conductor lines. In the normal case, the double-layer capacitor 7 supplies the drives of the MAS. Their consumption is approximately dependent on the distance traveled without an external energy supply, which should be planned well in advance, since the spatial arrangement of the charging infrastructure is known.

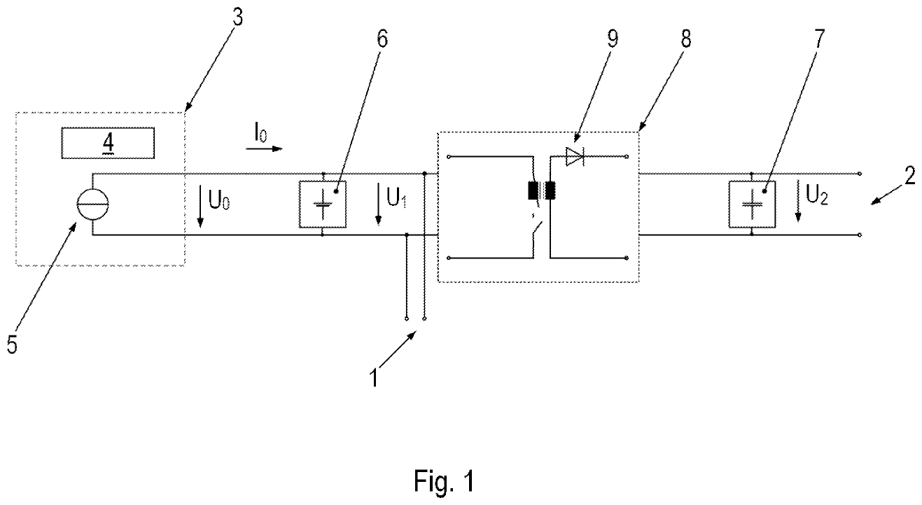

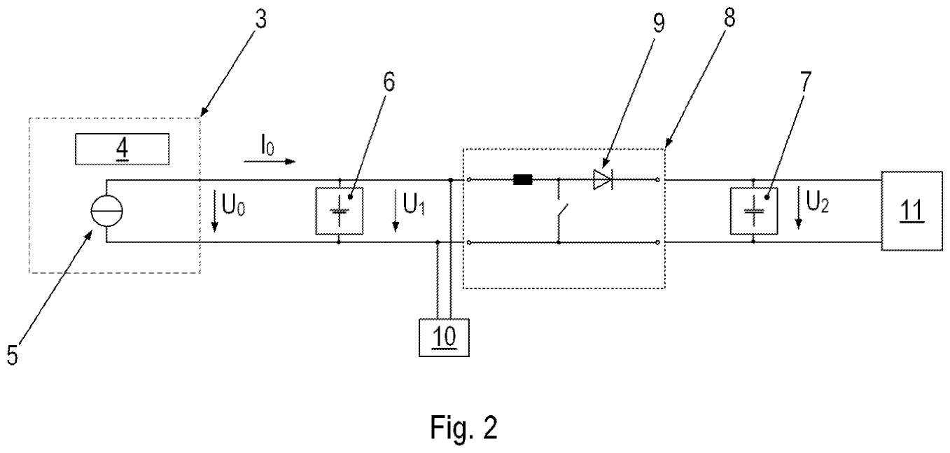

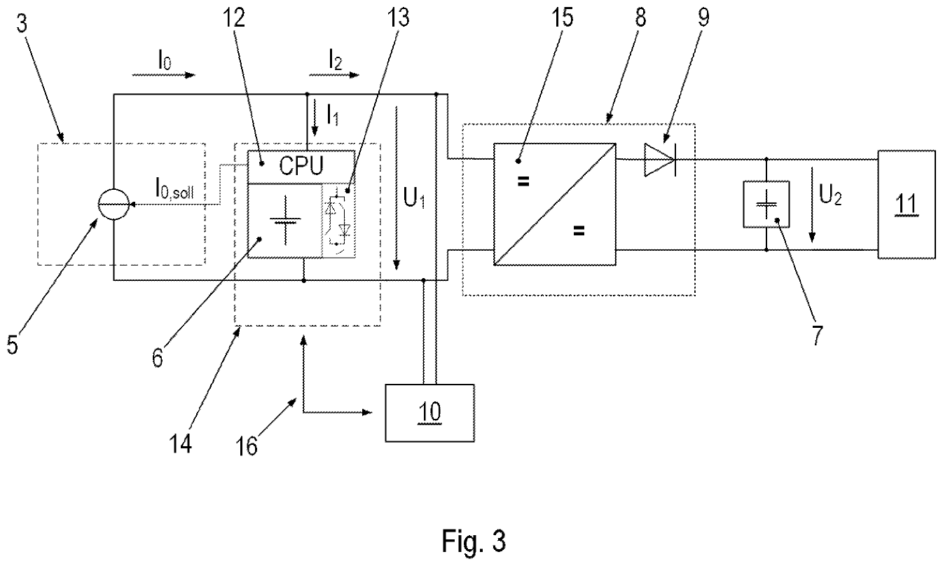

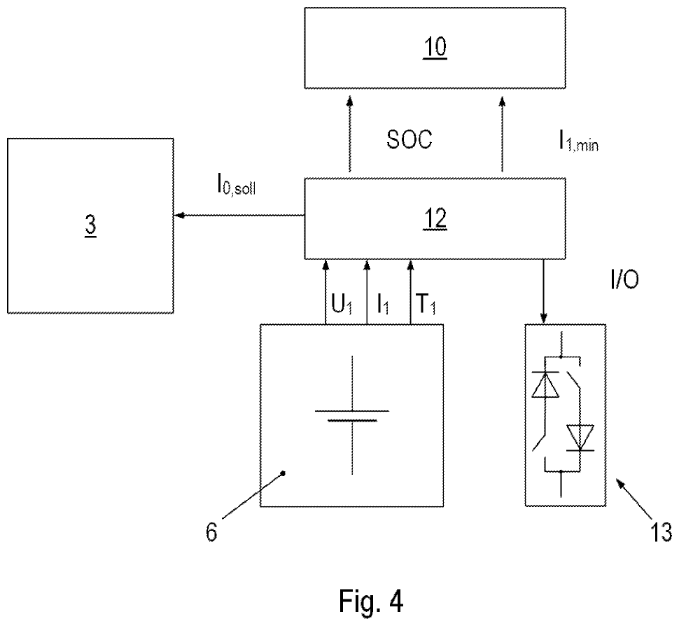

In the exemplary embodiments illustrated in FIG. 1 and FIG. 2, the charger 3 regulates the output current I₀ of the variable current source 5 itself by its regulator 4. This output current I₀ is divided into the current I₁ that flows through the battery store, i.e., the charging current of the battery store, and the current I₂, which flows into the converter device 8. In order to prevent the battery store from being destroyed, for example, due to overcharging, certain measures are, for example, taken to ensure that the battery store is charged correctly. For this purpose, the electric vehicle in the exemplary embodiment illustrated in FIG. 3 has a so-called intelligent battery 14, the detailed structure of which is illustrated again in FIG. 4.

The exemplary embodiment illustrated in FIG. 3 differs from that illustrated in FIG. 2 on the one hand in that a converter device 8 is present, which is schematically illustrated as the DC/DC converter 15 having downstream diode 9. This representation is intended to express that the converter device 8 is a unidirectional DC/DC converter, which permits a power or energy flow only from the charger 3 to the double-layer capacitor 7. A power or energy flow from the double-layer capacitor 7 to the battery store 6 is prevented by the converter device 8. Specific configurations of the converter device are illustrated in FIGS. 1 and 2. However, other specific configurations are also possible, as long as unidirectionality is provided.

Another difference is that the vehicle has an intelligent battery 14 in the exemplary embodiment illustrated in FIG. 3. As schematically illustrated in FIG. 4, this intelligent battery 14 includes a battery management system 12, a battery store 6, and a bidirectional switch 13. The bidirectional switch 13 is optional. The battery management system 12 can also be designated as an energy storage control device.

In the present exemplary embodiment, characteristic variables of the battery store 6 are measured and thus detected, for example, by sensors arranged in the battery store 6. These variables characterize the state of the battery store 6 and are, for example, the voltage U₁ applied to the battery store 6, the current I₁ flowing through the battery store 6, and the temperature T₁ prevailing in the battery store 6. It is also possible that, for example, only the voltage U₁ is detected. The detected state values are made available to the battery management system 12 and the battery management system 12 controls or regulates the output current I₀ of the charger 3 depending on at least one of these state values. For this purpose, the battery management system 12 specifies a setpoint value for regulation or control to the charger 3. In the exemplary embodiment illustrated in FIG. 3, this setpoint value I_{0,soll} is a setpoint value for the output current I₀. A value for the charging current I₁ flowing through the battery store 6 can be set via this setpoint value I_{0,soll}. This ensures that the battery store 6 is always charged using a permissible charging current I₁. It is therefore protected from destruction or misuse. The regulation or control of the charging process is specified by the intelligent battery 14, so that the charger 3 can be configured in a simple manner. In this case, only one variable current source 5 is necessary, so that the output current I₀ is influenceable by the battery management system 12. With this method, it is permissible for the charger 3 to set a lower current than the setpoint value I_{1,soll}. This is the case, for example, when the capacity of the charger is too low for the current I_{0,soll} specified by the intelligent battery 14. It is important that the current I₁ flowing through the battery store cannot be greater than permitted, so that the battery is protected against overloading. The setpoint value I_{0,soll} therefore represents a maximum upper limit, which is dynamically adjustable.

For example, the intelligent battery 14 includes a bidirectional switch 13, using which it is possible to prevent the flow of power or energy to and from the battery store 6 independently of one another. For example, the bidirectional switch includes, as schematically illustrated in FIG. 4, two parallel current branches, each having an activatable switch and a diode, and the diodes are connected in antiparallel. In this manner, overcurrent and/or overvoltage and/or overtemperature protection is implementable in that the battery management system 12 interrupts the energy supply or discharge of the battery store 6 depending on the state variables.

For example, the intelligent battery 14 is a separate structural unit, so that all components are integrated in one housing and a replacement of the intelligent battery 14 is thus provided. This also makes it possible to refit the electric vehicle depending on the logistical application. The regulation or control of the battery charging current I1 is always taken over by the intelligent battery 14 itself, so that the same charger 3 and the same converter device 8 are always usable for different battery stores 6 having different parameters.

The battery management system 12 is, for example, connected to the vehicle controller 10 via a communication link 16. Various application parameters are transmittable via this communication link 16. For example, it is possible for the battery management system 12 to communicate the maximum possible discharge current I_{1,min} to the vehicle controller 10. Another application parameter can be, for example, the state of charge (SOC) or an aging state of the battery store 6. In this manner, the vehicle controller 10 is always informed about the present status of the battery store 6.

### LIST OF REFERENCE NUMERALS

1 first DC connection
2 second DC connection
3 energy supply unit
4 regulator
5 variable power source
6 first energy storage device
7 second energy storage device
8 converter device
9 diode
10 first consumer
11 second consumer
12 energy storage control device
13 bidirectional switch
14 intelligent battery
15 DC/DC converter
16 communication link

1-15. (canceled)

16. A method for operating an electric vehicle including an electric traction drive device adapted to drive the vehicle, a control device adapted to control driving movement of the vehicle, a first energy storage device adapted to supply the control device with a first DC voltage, a second energy storage device adapted to supply the traction drive device with a second DC voltage, and an energy supply unit adapted to provide an output DC voltage, the first energy storage device being connected to the second energy storage device via a converter device, the first energy storage device being connected to the energy supply unit, the converter device adapted to convert the first DC voltage into the second DC voltage, comprising:
preventing a power flow from the second energy storage device.

17. The method according to claim 16, wherein the vehicle is arranged as a driverless mobile assistance system of an intralogistics application, the driving movement includes traction of the vehicle, the first energy storage device includes a rechargeable battery storage device, the second energy storage device includes a double-layer capacitor device and/or is chargeable and dischargeable more rapidly than the first energy storage device, the energy supply unit is adapted to provide the output DC voltage periodically, the first energy storage device is electrically connected to the second energy storage device via the converter device, the first energy storage device is electrically connected to the energy supply unit such, the output DC voltage substantially equals the first DC voltage, the first DC voltage is lower than the second DC voltage and/or is an extra-low voltage, and the power flow from the second energy storage device to the first energy storage device is prevented at any time.

18. The method according to claim 16, wherein the converter device includes a unidirectional DC/DC converter, a step-up converter, and/or a flyback converter adapted to prevent the power flow from the second energy storage device to the first energy storage device.

19. The method according to claim 16, wherein the vehicle includes an energy storage control device, the method further comprising:
detecting a state value of the first energy storage device; and
transmitting the state value to the energy storage control device.

20. The method according to claim 19, wherein the state value includes a voltage applied to the first energy storage device, a current flowing through the first energy storage device, and/or a temperature prevailing in the first energy storage device.

21. The method according to claim 19, wherein an output current provided by the energy supply unit is regulated and/or controlled by the energy storage control device as a function of the state value.

22. The method according to claim 21, wherein a value for the output current is specified as a setpoint value.

23. The method according to claim 19, further comprising determining, by the energy storage control device, an application parameter from the state value.

24. The method according to claim 23, further comprising transmitting the application parameter to the control device.

25. The method according to claim 23, wherein the application parameter includes a value of a maximum current dischargeable by first energy storage device, a state of charge of the first energy storage device, and/or an aging state of the first energy storage device.

26. The method according to claim 16, further comprising preventing a power flow to the first energy storage device and/or from the energy supply unit to the first energy storage device in response to a voltage applied at the first energy storage device exceeding a predefined maximum voltage, a current flowing through the first energy storage device exceeds a predefined maximum current, and/or a temperature prevailing in the first energy storage device exceeds a predefined maximum temperature.

27. The method according to claim 16, further comprising preventing a power flow from the first energy storage device and/or to the second energy storage device from the first energy storage device in response to a voltage applied at the first energy storage device falling below a predefined minimum voltage, a current flowing through the first energy storage device falling below a predefined minimum current, and/or a temperature prevailing in the first energy storage device exceeding a predefined maximum temperature.

28. The method according to claim 26, wherein the power flow to the first energy storage device is prevented by a bidirectional switch and/or by activating the bidirectional switch by the energy storage control device.

29. The method according to claim 27, wherein the power flow from the first energy storage device is prevented by a bidirectional switch and/or by activating the bidirectional switch by the energy storage control device.

30. The method according to claim 16, wherein energy is supplied to the energy supply unit with or without contact and/or in certain time intervals while driving.

31. A device for supplying a first consumer of an electric vehicle using a first DC voltage and a second consumer using a second DC voltage, including a first energy storage device, a second energy storage device, an energy supply unit adapted to provide an output DC voltage, the first energy storage device adapted to supply the first DC voltage, the second energy storage device adapted to supply the second DC voltage, the first energy storage device being connected to the second energy storage device via a converter device, the first energy storage device being connected to the energy supply unit, the converter device adapted to convert the first DC voltage into the second DC voltage, wherein the device is configured to prevent a power flow from the second energy storage device to the first energy storage device.

32. The device according to claim 31, wherein the vehicle includes a driverless, mobile assistance system of an intralogistics application, the first energy storage device includes a rechargeable battery storage device, the second energy storage device includes a double-layer capacitor and/or is chargeable and dischargeable more rapidly than the first energy storage device, the energy supply unit is adapted to provide the output DC voltage periodically, the first energy storage device is electrically connected to the second energy storage device via the converter device, the converter device includes a unidirectional DC/DC converter, a step-up converter, and/or a flyback converter, the first energy storage device is electrically connected to the energy supply unit, the output DC voltage substantially equals the first DC voltage, the first DC voltage is less than the second DC voltage and/or is an extra-low voltage, and the device is adapted to prevent to the power flow from the second energy storage device to the first energy storage device at any time.

33. The device according to claim 31, further comprising an energy storage control device, the device being adapted to detect and transmit to the energy storage control device a state variable.

34. The device according to claim 33, wherein the state variable includes a voltage applied at the first energy storage device, a current flowing through the first energy storage device, and/or a temperature prevailing in the first energy storage device.

35. The device according to claim 33, wherein the energy supply unit is adapted to regulate and/or control an output current provided by the energy supply unit as a function of the state value.

36. The device according to claim 35, wherein a value for the output current is predeterminable as a setpoint value.

37. The device according to claim 31, further comprising a bidirectional switch adapted to prevent a power flow from and to the first energy storage device.

38. The device according to claim 37, wherein the bidirectional switch is adapted to prevent the power flow from and to the first energy storage device in certain time intervals and/or the energy storage control unit is adapted to activate the bidirectional switch.

39. The device according to claim 37, wherein the first energy storage device, an energy storage control device, and the bidirectional switch are combined in one structural unit.

40. The device according to claim 39, wherein the structural unit is separable from the device and is replaceable.

41. An electric vehicle, comprising:
a first consumer adapted to use a first DC voltage;
a second consumer using a second DC voltage;
a first energy storage device;
a second energy storage device;
an energy supply unit adapted to provide an output DC voltage; and
a device adapted to prevent a power flow from the second energy storage device to the first energy storage device;
wherein the first energy storage device is adapted to supply the first DC voltage, the second energy storage device is adapted to supply the second DC voltage, the first energy storage device is connected to the second energy storage device via a converter device, the first energy storage device is connected to the energy supply unit, and the converter device is adapted to convert the first DC voltage into the second DC voltage; and
wherein the first consumer includes a control device adapted to control a driving movement of the vehicle and the second consumer includes an electric traction drive device adapted to drive the vehicle, a lifting device, and/or a handling device.
